(19) United States
(12) Patent Application Publication
(10) Pub. No.: US 2015/0100333 A1
(43) Pub. Date: Apr. 9, 2015

(54) SYSTEMS AND METHODS FOR VERIFYING PROTOCOL COMPLIANCE

(71) Applicant: CLINICAL LENZ, INC., HILLSBOROUGH, NJ (US)

(72) Inventors: Lori Fitzgerald, Hillsborough, NJ (US); Timothy Wildman, Metamora, IN (US); William Collins, Menlo Park, CA (US)

(73) Assignee: CLINICAL LENZ, INC., HILLSBOROUGH, NJ (US)

(21) Appl. No.: 14/283,883

(22) Filed: May 21, 2014

Related U.S. Application Data
(60) Provisional application No. 61/888,153, filed on Oct. 8, 2013.

(51) Int. Cl. G06Q 30/00; G06Q 50/22

(52) U.S. Cl. CPC G06Q 30/018; G06Q 50/22
USPC 705/2

(57) ABSTRACT

A method includes receiving, from a mobile device and at a host device associated with a database storing medical procedures, a signal indicative of a credential of a user of the mobile device. Based on the credential, a first subset of medical procedures including fewer medical procedures than the set of medical procedures is associated with the mobile device. The host device receives a signal indicative of healthcare data from the mobile device. Based on the healthcare data, a signal is sent to cause the mobile device to display a second subset of medical procedures including fewer medical procedures than the first subset of medical procedures. The host device receives a signal indicative of a selection of a medical procedure from the second subset of medical procedures from the mobile device and a signal is sent to cause the display to display a first step of the medical procedure.

### CROSS-REFERENCE TO RELATED APPLICATIONS

This application claims priority to and the benefit of U.S. Provisional Patent Application Ser. No. 61/888,153 entitled, “Systems and Methods for Verifying Protocol Compliance,” filed Oct. 8, 2013, the disclosure of which is incorporated herein by reference in its entirety.

### BACKGROUND

The embodiments described herein relate generally to protocol compliance and, more particularly, to systems and methods for verifying protocol compliance using a mobile electronic device.

Most hospitals and/or medical centers have established protocols (e.g., corporate and/or procedural rules or guidelines) that are associated with, for example, providing care to a patient, record keeping, inventory tracking, and/or the like. In some instances, adherence to some such protocols can be crucial to providing adequate care to a patient as well as ensuring that caregivers are fulfilling the legal responsibility to their patients (e.g., avoidance of medical negligence and/or malpractice, etc.). To verify adherence to the protocols, caregivers often record their activities during a shift (e.g., rounds, etc.), which can then be compared to the protocols and/or reviewed by executive leadership or the like. Furthermore, in order to maintain, for example, accreditation from the Joint Commission on Accreditation of Hospitals, documentation of the adherence to the established protocols is required. In some instances, insurance companies may require similar documentation in order for the medical center to be properly insured. Such a method of recordation can be time consuming (e.g., often about a quarter or more of the caregivers total time during a shift). Moreover, some caregivers have very little time while attending to patients which can lead to the recordation of the caregiver's activities being performed at the end of a shift. In some instances, the delay in the recordation of the caregiver's activities can lead to errors or delay in follow-up treatment and/or can otherwise lead to negative impacts on patient safety and/or clinical outcomes.

Thus, a need exists for improved systems and methods for verifying protocol compliance, for example, in real-time and/or in an automated process.

### SUMMARY

Systems and methods for verifying clinical compliance are described herein. In some embodiments, a method includes receiving, at a host device from a mobile device, a signal indicative of a credential of a user of the mobile device. The host device is associated with a database storing a set of medical procedures. Based on the credential, a first subset of medical procedures from the set of medical procedures is associated with the mobile device. The first subset of medical procedures includes fewer medical procedures than the set of medical procedures. A signal from the mobile device, which is indicative of healthcare data (e.g., patient data and/or clinical data), is received at the host device. The method includes sending a signal to cause a display associated with the mobile device to display, based on the healthcare data, a second subset of medical procedures from the first subset of medical procedures. The second subset of medical procedures includes fewer medical procedures than the first subset of medical procedures. The host device receives, from the mobile device, a signal indicative of a selection of a medical procedure from the second subset of medical procedures. The method includes sending a signal configured to cause the display to display a first step of the medical procedure.

### BRIEF DESCRIPTION OF THE DRAWINGS

FIG. 1 is a schematic illustration of a compliance verification system according to an embodiment.

FIG. 2 is a schematic illustration of an electronic device used in the compliance verification system of FIG. 1.

FIG. 3 is a schematic illustration of a host device used in the compliance verification system of FIG. 1.

FIG. 4 is a flowchart illustrating a method of using a compliance verification system according to an embodiment.

### DETAILED DESCRIPTION

Systems and methods for verifying protocol compliance are described herein. In some embodiments, a method includes receiving, at a host device from a mobile device, a signal indicative of a credential of a user of the mobile device. The host device is associated with a database storing a set of medical procedures. Based on the credential, a first subset of medical procedures from the set of medical procedures is associated with the mobile device. The first subset of medical procedures includes fewer medical procedures than the set of medical procedures. A signal from the mobile device, which is indicative of healthcare data (e.g., patient data and/or clinical data), is received at the host device. The method includes sending a signal to cause a display associated with the mobile device to display, based on the healthcare data, a second subset of medical procedures from the first subset of medical procedures. The second subset of medical procedures includes fewer medical procedures than the first subset of medical procedures. The host device receives, from the mobile device, a signal indicative of a selection of a medical procedure from the second subset of medical procedures. The method includes sending a signal configured to cause the display to display a first step of the medical procedure.

In some embodiments, an apparatus includes a processor module that is configured to send a signal to a host device to cause the host device to define a first subset of medical procedures from a set of medical procedures. The processor module is configured to cause a display module to display a second subset of medical procedures from the first subset of medical procedures. The processor module is configured to cause the display module to display a first step of a medical procedure from the second subset of medical procedures. The processor module is configured to send, to the host device, a signal indicative of a completion of the first step of the medical procedure and to display a second step of the medical procedure.

In some embodiments, a non-transitory processor-readable medium storing code representing instructions to cause a processor to perform a process includes code to receive, from a mobile device, a signal indicative of a selection of a medical procedure from a list of medical procedures displayed to a user of the mobile device. Data is received from the mobile device, which is associated with a completion of a first step of the medical procedure. Based on a determination that the data meets a completion criteria an indication of the completion of the first step is stored. Based on the indication of the completion of the first step a signal configured to cause the mobile device to display a second step of the medical procedure is sent to the mobile device.

In some embodiments, an apparatus includes a processor module is configured to cause a display module to display a first subset of medical procedures. The first subset of medical procedures is from a second subset of medical procedures. A number of medical procedures in the first subset of medical procedures is less than a number of medical procedures in the second subset of medical procedures. The processor module is configured to cause the display module to display (1) a first step of a medical procedure from the first subset of medical procedures and (2) a second step of the medical procedure. The processor module is configured to send, to a host device, a signal indicative of a completion status of the first step of the medical procedure and a signal indicative of a completion status of the second step of the medical procedure. Based on the completion status of the first step of the medical procedure and the completion status of the step of the medical procedure, the processor module is configured to store a compliance report.

In some embodiments, a method includes receiving, at a host device via a network, a signal from an electronic device in communication with the network. The signal includes data associated with, for example, a clinical process. The data from the electronic device is analyzed. The method includes associating data from the electronic device to data associated with a clinical protocol from a set of clinical protocols stored in a database operably coupled to the host device. Compliance of the clinical protocol is verified based at least in part on a comparison of the data from the electronic device and the data stored in the database. A signal is sent to the electronic device that is indicative of an instruction to present, on a display of the electronic device, data associated with at least one of the clinical process or the verification of compliance with the clinical protocol.

As used in this specification, the singular forms “a,” “an” and “the” include plural referents unless the context clearly dictates otherwise. Thus, for example, the term “a module” is intended to mean a single module or a combination of modules.

As used herein, the term “module” can refer to, for example, any assembly and/or set of operatively-coupled electrical components, and can include, for example, a memory, a processor, electrical traces, optical connectors, software (executing in hardware), and/or the like. For example, a module executed in the processor can be any combination of hardware-based module (e.g., a field-programmable gate array (FPGA), an application specific integrated circuit (ASIC), a digital signal processor (DSP)) and/or software-based module (e.g., a module of computer code stored in memory and/or executed at the processor) capable of performing one or more specific functions associated with that module.

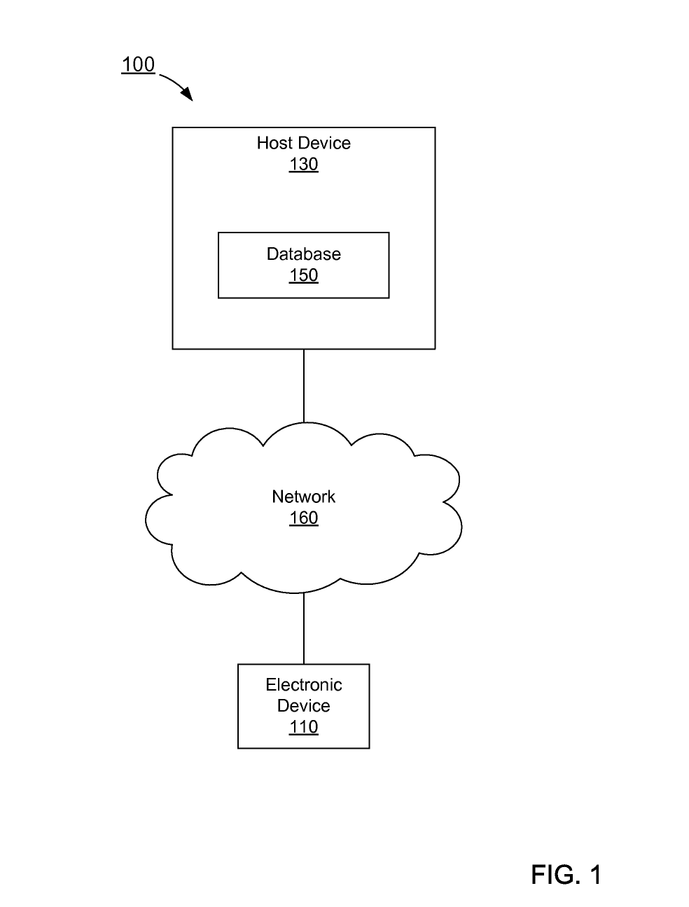

FIG. 1 is a schematic illustration of a system 100 according to an embodiment. As illustrated, the system 100 includes an electronic device 110 and a host device 130 that are in communication via a network 160. The system 100 also includes a database 150 that is included in and/or operably coupled to the host device 130. The system 100 can be used in any suitable environment in which it is desirable to verify compliance with a set of protocols in substantially real-time and in an at least partially automatic manner. For example, in some embodiments, the system 100 can be used in a hospital or medical center environment to ensure compliance with corporate and/or procedural protocols. Although the system 100 is shown in FIG. 1 as including a single electronic device 110, in other embodiments, the system 100 can include any number of electronic devices that can be similar in form and function as the electronic device 110.

As described above, the electronic device 110 (e.g., a mobile electronic device) and the host device 130 are in communication via the network 160. The network 160 can be any suitable network or combination of networks. For example, in some embodiments, the network 160 can be a local area network (LAN), a wide area network (WAN), a metropolitan area network (MAN), a worldwide interoperability for microwave access network (WiMAX), an intranet, the Internet, an optical fiber (or fiber optic)-based network, a virtual network, and/or any combination thereof. Moreover, at least a portion of the network can be implemented as a wireless network. For example, in some embodiments, the electronic device 110 can be in communication with the network 160 via a wireless access point or the like (not shown in FIG. 1) that is operably coupled to the network 160. The host device 130 can similarly be in communication with the network 160 via a wired or wireless connection.

The electronic device 110 can be any suitable electronic device. For example, in some embodiments, the electronic device 110 is a mobile electronic device that is wirelessly in communication with the network 160 and/or the host device 130. In some embodiments, the electronic device 110 can be a wearable mobile electronic device that can include a head-mounted display (e.g., a wearable visual display). For example, in some embodiments, the electronic device 110 can be a Google Glass® device or the like. With the electronic device 110 being a wearable head-mounted electronic device, the electronic device 110 can record a video with substantially the same field of view as the user of the electronic device 110. As such, the electronic device 110 can be used to facilitate a user's (e.g., a nurse, a doctor, a physician, a technician, a surgeon, etc.) compliance with a set of protocols associated with a clinical process or procedure and/or any other job function. In other words, the electronic device 110 can be used to confirm a protocol associated with a clinical process is being followed and/or has been accomplished.

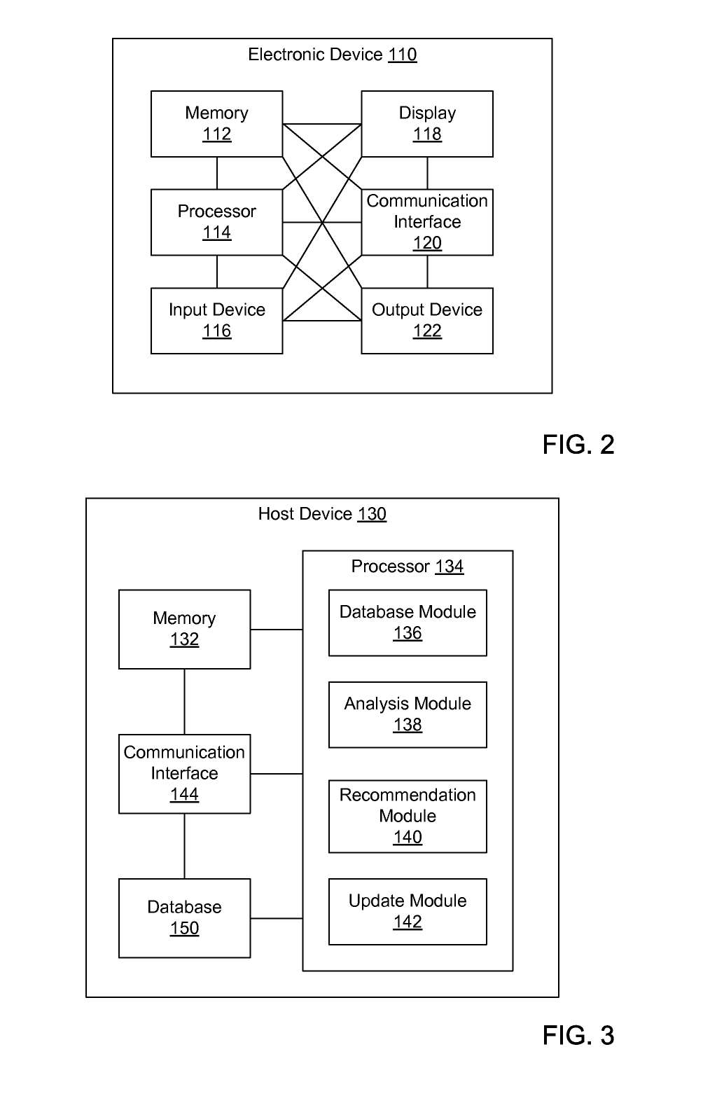

As shown in FIG. 2, the electronic device 110 includes a memory 112, a processor 114, an input device 116, a display 118, a communication interface 120, and an output device 122. The memory 112 can be, for example, a random access memory (RAM), a memory buffer, a hard drive, a read-only memory (ROM), an erasable programmable read-only memory (EPROM), and/or the like. In some embodiments, the memory 112 can store, for example, one or more software modules and/or code that can include instructions to cause the processor 114 to perform one or more processes, functions, and/or the like. For example, in some embodiments, the memory 112 can include a software module and/or code that can include instructions to cause the processor 114 to receive an input associated with a clinical procedure. The memory 112 can further include instructions to cause the communication interface 120 to send and/or receive one or more signals associated with the input to or from, respectively, the host device 130, as described in further detail herein.

The processor 114 can be any suitable processing device configured to run or execute a set of instructions or code such as, for example, a general purpose processor, a central processing unit (CPU), an accelerated processing unit (APU), an application specific integrated circuit (ASIC), a field programmable gate array (FPGA), and/or the like. As such, the memory 112 can store instructions to cause the processor 114 to execute modules, processes, and/or functions associated with, for example, the recordation and/or presentation of data associated with one or more clinical processes, as described in further detail herein.

The input device 116 can be any suitable device and/or combination of devices. For example, in some embodiments, the input device 116 can be an input port or the like that can be operably coupled to the memory 112 and the processor 114, as well as, for example, a camera, a bar code reader, and radio frequency identification (RFID) tag device, a haptic input device, an audio input device, an accelerometer, and/or the like (not shown in FIGS. 1 and 2). The input device 116 can be configured to receive a signal (e.g., from a camera) associated with a clinical procedure and upon receipt, can forward the signal and/or otherwise send another signal representing that signal to the processor 114 for any suitable processing and/or analyzing process, as described in further detail herein.

The display 118 of the electronic device 110 can be any suitable display that can provide a visual user interface to the electronic device 110. In some embodiments, the display 118 can be an optical head-mounted display. For example, the display 118 can be a cathode ray tube (CRT) display, a liquid crystal display (LCD) display, a light emitting diode (LED) display, and/or the like that can have a reduced size suitable from a head-mounted display. As described in further detail herein, the display 118 can provide the user interface for a software application (e.g., mobile application, internet web browser, and/or the like). In such embodiments, the display 118 can graphically represent any suitable portion of the system 100 (e.g., a webpage, a task list, a picture, a video, location data, patient data, clinical data, relevant protocol data, healthcare data, and/or the like).

The communication interface 120 of the electronic device 110 can be any suitable device that can communicate with the network 160. More specifically, the communication interface 120 can include one or more wireless interfaces, such as, for example, Ethernet interfaces, optical carrier (OC) interfaces, and/or asynchronous transfer mode (ATM) interfaces. In some embodiments, the communication interface 120 can be, for example, a network interface card and/or the like that can include at least a wireless radio (e.g., a WiFi® radio, a Bluetooth® radio, etc.). As such, the communication interface 120 can send signals to and/or receive signals from the host device 130.

The output device 122 can be any suitable output device. For example, in some embodiments, the output device 122 can be a speaker that can receive a signal to cause the speaker to output audible sounds such as, for example, instructions, verification questions, confirmations, etc. In other embodiments, the output device 122 can be a haptic device that can be in contact with a portion of the user's head. In such embodiments, the haptic output device can receive a signal to cause the haptic output device to vibrate at any number of different frequencies. Thus, with the haptic output device in contact with a portion of the user's head, the vibration of the output device 122 can vibrate, for example, the bones of the ear at a desired set of frequencies, thereby allowing the user to audibly hear sounds associated with the vibrations.

As described above, the electronic device 110 can be a wearable electronic device that can be worn by a health care professional (e.g., a nurse, a doctor, a physician, a surgeon, a technician, etc.) to facilitate compliance with a set of protocols (e.g., clinical protocols, corporate protocols, etc.). The electronic device 110 can also be used to, for example, locate a user; verify a user based on a set of credentials (e.g., based on a password, retina scan, finger print, ID badge scan, voice recognition, and/or the like); prioritize responsibilities of a user (e.g., based on a need or level of care of patients for whom the user is responsible); instruct a user in a process and/or procedure (e.g., a clinical procedure, a stocking and/or inventory procedure, a recordation procedure, etc.); alert a user about any process step or task and/or alert a user of noncompliance with a protocol; display and/or otherwise present relevant healthcare (e.g., patient data or clinical data); indicate a status of the user to any other user of the system 100 or vice versa; indicate an amount of time remaining in the user's shift; provide information associated with the location, status, and/or estimated time of arrival of medical equipment, transport equipment, drugs, and/or the like; record (e.g., as a video, an audio, and/or a haptic input), in at least a semi-automatic manner, a clinical process and/or procedure to document data associated therewith (e.g., a date and/or time of the process, a location where the process was performed, a patient on which the process was performed, a specific user performing the process, equipment usage, support staff, drug formulations administered, duration of the process, and/or any other relevant information); and/or the like. Moreover, the electronic device 110 can send one or more signals associated with any of the parameters described above to the host device 130 for further processing and/or analysis and once processed and/or analyzed, can receive one or more signals from the host device 130 associated with the processed and/or analyzed parameter. Upon receipt, the electronic device 110 can present (e.g., on the display 118 and/or via the output device 122) data associated with the parameter, data associated with the processed and/or analyzed parameter, a recommendation, and/or any combination thereof, as described in further detail herein.

Although not shown in FIG. 1, the electronic device 110 can include and/or can be operably coupled to any other suitable device. For example, in some embodiments, the electronic device 110 can be operably coupled to an external power source, a docking station, a storage device (e.g., an external memory device such as, Negate-And-Not-And (NAND) flash memory, RAM, a hard-drive, an external and/or tethered processing device, etc.), a display (e.g., a television or computer monitor such as a cathode ray tube (CRT) display, light emitting diode (LED) display, a liquid crystal display (LCD), etc.), and/or any other suitable device. In some embodiments, the electronic device 110 can be used and/or can be operably coupled to a secondary electronic device or the like such as, for example, a smartphone and/or a tablet. In such embodiments, the electronic device 110 (e.g., the wearable electronic device and/or the wearable visual display) can be in communication with the secondary electronic device via any suitable communication mode and/or network such as, for example, Bluetooth®, near field communication (NFC), WiFi®, and/or the like. In some embodiments, the electronic device 110 can be in communication with the secondary electronic device via the network 160 (described above).

Referring back to FIG. 1, the host device 130 can include and/or can otherwise be operably coupled to the database 150. The database 150 can be, for example, a table, a repository, a relational database, an object-oriented database, an object-relational database, a SQL database, and XML database, and/or the like. In some embodiments, the database 150 can be stored in a memory of the host device 130 and/or the like. In other embodiments, the database 150 can be, for example, a network access storage device (NAS) and/or the like that is operably coupled to the host device 130. In some embodiments, the database 150 can be in communication with the host device 130 via the network 160. In such embodiments, the database 150 can communicate with the network 160 via a wired or a wireless connection. The database 150 can be configured to at least temporarily store data such as, for example, data associated with a set of clinical and/or corporate processes, procedures, and/or protocols. In some embodiments, at least a portion of the database 150 can be stored in, for example, the memory 112 of the electronic device 110. In some embodiments, the database 150 can at least temporarily store patient records and/or the like. In some embodiments, the database 150 can at least temporarily store user information such as user credentials, privileges, access allowances or restrictions, job descriptions, tasks, to do lists, and/or the like, as described in further detail herein.

The host device 130 can be any type of device that can send data to and/or to receive data from one or more electronic devices (e.g., the electronic device 110) and/or databases (e.g., the database 150) via the network 160. In some embodiments, the host device 130 can function as, for example, a server device (e.g., a web server device), a network management device, an administrator device, and/or so forth. The host device 130 can be located within a central location, distributed in multiple locations, and/or a combination thereof. Moreover, some or all of a set of components of the host device 130 can be located within a user device (e.g., the electronic device 110) and/or any other device or server in communication with the network 160.

As shown in FIG. 3, the host device 130 includes a memory 132, a processor 134, and a communication interface 144, and the database 150. The communication interface 144 of the host device 130 can be any suitable device that can communicate with the network 160 via a wired or wireless communication. More specifically, the communication interface 144 can include one or more wired or wireless interfaces, such as, for example, Ethernet interfaces, optical carrier (OC) interfaces, and/or asynchronous transfer mode (ATM) interfaces. In some embodiments, the communication interface 144 can be, for example, an Ethernet port, a network interface card, and/or the like. In some embodiments, the communication module 144 can include a wireless radio (e.g., a WiFi® radio, a Bluetooth® radio, etc.) that can communicate with the network 160.

The memory 132 can be, for example, a random access memory (RAM), a memory buffer, a hard drive, a read-only memory (ROM), an erasable programmable read-only memory (EPROM), and/or the like. In some embodiments, the memory 132 can be configured to store, for example, one or more software modules and/or code that can include instructions to cause the processor 134 to perform one or more processes, functions, and/or the like. For example, in some embodiments, the memory 132 can include a software module and/or code that can include instructions to cause the communication interface 144 to receive and/or send one or more signals from or to, respectively, the electronic device 110 (via the network 160). In some instances, the one or more signals can be associated with data relating to a clinical process or procedure, and/or the like. The memory 132 can further include instructions to cause the processor 134 to analyze, classify, compare, verify, and/or otherwise process data received from the electronic device 110. In addition, the memory 132 can include instructions to cause the processor 134 to query, update, and/or access data stored in the database 150, as described in further detail herein.

The processor 134 of the host device 140 can be any suitable processing device configured to run or execute a set of instructions or code such as, for example, a general purpose processor, a central processing unit (CPU), an accelerated processing unit (APU), an application specific integrated circuit (ASIC), a field programmable gate array (FPGA), a front end processor, a network processor, and/or the like. As such, the memory 132 can store instructions to cause the processor 134 to execute modules, processes, and/or functions associated with, for example, sending and/or receiving signals via the network 160, analyzing; classifying, comparing, verifying, and/or processing data; and/or querying, updating, and/or otherwise accessing data stored in the database 150, and/or the like. More particularly, as shown in FIG. 3, the processor 134 can include and/or can execute a set of modules (e.g., stored in the memory 132) such as, for example, a database module 136, an analysis module 138, a recommendation module 140, and an update module 142.

The database module 136 can be configured to query and/or retrieve data from the database 150. For example, in some instances, the database module 136 can receive a signal indicative of an instruction to query the database 150 from, for example, the analysis module 138 and/or any other module. The database module 136 can query and/or search the database 150 using any suitable searching method (e.g., a keyword search, searching a memory cache, and/or the like) to retrieve a desired set of information. In some instances, the database module 136 can be configured to query the database 150 to verify, for example, a username and/or password. Upon verification, the database module 136 can send a signal associated with the verification to any other suitable module. In other instances, the database module 136 can receive a signal associated with an instruction to query and retrieve data. In such instances, the database module 136 can send a signal associated with the retrieved data to any other module and/or the like.

The analysis module 138 can be configured to identify data associated with a user, a patient, a process, a procedure, a protocol, a location, and/or the like. For example, in some instances, the analysis module 138 can receive a signal from the electronic device 110 (e.g., via the network 160 and the communication devices 120 and 144) associated with a user login, a procedure, a location, a patient, etc. and can analyze any portion of data included therein to define, for example, an analyzed and/or searchable data set. In some instances, the analysis module 138 can send a signal to the database module 136 to cause the database module 136 to query the database 150 based at least partially on the analyzed and/or searchable data set. Upon completion of the query, the database module 136 can send a signal associated with the results of the query to the analysis module 138, which can, in turn, analyze, compare, and/or verify the results of the query with respect to the analyzed and/or searchable data set. In some instances, the analysis module 138 can send a signal associated with the analysis, comparison, and/or verification to the electronic device 110 (e.g., via the communications device 144 and the network 160), as described in further detail herein.

The recommendation module 140 can be configured to, for example, determine a set of actions to be performed by the user of the electronic device 110. For example, in some instances, the electronic device 110 can send a signal to the host device 130 that is associated with, for example, a location within a medical center (e.g., a hospital). In some instances, the recommendation module 140 can receive data associated with the signal from the electronic device 110 and can determine, based at least partially on a user's credentials, a subset of procedures, processes, and/or authorization or restrictions for that user in that location. For example, in some instances, a user can enter a patient's room and, based on the user's credentials, the recommendation module 140 can determine a subset of procedures from the set of procedures stored in the database 150 that the user is authorized to perform on or for that patient. By way of example, in some instances, the recommendation module 140 may determine that a nurse is authorized to draw blood but not authorized to deliver a drug to a patient. In this manner, the recommendation module 140 can send a signal to the electronic device 110 (e.g., via the communication interface 144 and the network 160) that can cause the electronic device 110 to indicate to the user a subset of procedures from the set of procedures stored in the database 150 he or she is authorized to perform in the given location. In some instances, the electronic device 110 can present the subset of procedures in a visual format (e.g., on the display 118) or an audio format (e.g., via the output device 122). Although described as making recommendations based on location, the recommendation module 140 can make recommendations based on any suitable data such as, for example, user credentials, user preference, time, velocity (e.g., walking normally or at a faster pace), acceleration, and/or the like.

The update module 142 can be configured to update the database 150. For example, a user can perform a procedure such as delivering a drug to a patient. As described above, in some instances, the electronic device 110 can be configured to present (e.g., on the display 118) a subset of procedures that the user is authorized to perform on of for the patient. Therefore, with the subset of procedures presented, the user can select the procedure of delivering the drug to the patient. For example, in some instances, the user can select the procedure of delivering the drug to the patient by pressing a button on the electronic device 110, stating the procedure, making a gesture with his or her hands (recognized by an outward facing camera of the electronic device 110), looking at the procedure from the presented subset of procedures (recognized by an inward facing camera of the electronic device 110), and/or the like. With the procedure selected, the electronic device 110 can send a signal to the host device 130 associated with the selection. In this manner, the update module 142 can receive data associated with the signal from the electronic device 110 and can update data stored in the database 150 to reflect the selected procedure. In some embodiments, the update module 142 can also update data associated with the user of the electronic device 110 to represent, for example, a busy status and/or the like.

In some instances, once the selection of the procedure is made, the electronic device 110 can record (e.g., a video and/or an audio recording) of the delivery of the drug and can send a signal associated with the delivery of the drug to the host device 130. As such, the analysis module 138 can receive the signal (e.g., via the communication interface 144) and can determine, for example, a dosage, a time of delivery, and/or any other suitable data associated with the drug delivery. In such instances, the analysis module 138 can send a signal associated with the data to the update module 142 which can, in turn, update the data stored in the database 150 associated with that patient to reflect the drug delivery data. In some instances, prior to the analysis module 138 sending the signal to the update module 142, the host device 130 can send a signal to the electronic device 110 to cause the electronic device 110 to present a request to confirm (e.g., on the display 118 and/or via the output device 122) the data associated with the drug delivery and/or to confirm the completion of any process step during the procedure. The user can confirm the data and/or the process step by any of the methods described above with reference to the selection of the procedure. Once confirmed, the electronic device 110 can send a signal to the host device 130 and, upon receipt, the analysis module 138 can determine the data associated with the drug delivery and/or the completion of a process step has been confirmed. Thus, the analysis module 138 can send a signal to the update module 142 to cause the update module 142 to update the data stored in the database 150 to reflect the drug delivery data. Although described as updating based on delivering a drug (e.g., performing a procedure), the update module 142 can update the database 150 based on any suitable data such as, for example, location, inventory, user status, patient status, and/or the like.

As described above, the system 100 can be used in, for example, a hospital and/or medical center to facilitate compliance with established clinical and/or corporate protocols in substantially real-time and/or to otherwise assist a user of the electronic device 110 in substantially real-time. The following methods of use of the system 100 are shown by way of example and not limitation.

In some instances, a user can switch the electronic device 110 from an “off” or a “sleep” configuration to an “on” configuration. The electronic device 110 can prompt the user (either on the display 118 of the electronic device 110 and/or by an audible prompt produced by a speaker of the electronic device 110) to input that user's credentials. In some instances, the user can speak his or her username and password and/or otherwise make a predefined gesture associated with his or her credentials. In other instances, the user credentials can be collected (e.g., by one or more cameras) via facial recognition, a retina scan, a finger print scan, scanning of an ID badge, etc. Upon receiving the user's credentials, the electronic device 110 can send a signal associated with the user's credentials to the host device 130 via the network 160. The communication interface 144 of the host device 130 can receive the signal from the electronic device 110 and send an associated signal to the analysis module 138. The analysis module 138 can then perform any suitable analysis (e.g., a speech recognition analysis, retinal scan analysis, finger print analysis, etc.) to determine relevant data associated with the user's credentials. Once analyzed, the analysis module 138 can send a signal to the database module 136 to cause the database module 136 to query the database 150 based on the data determined from the analysis.

If a corresponding record of the data associated with the user's credentials is found in the database 150, the database module 136 can send a signal associated with a positive match of the user's credentials to the analysis module 138. Thus, the analysis module 138 can verify the user's credentials and send a signal to the electronic device 110 (e.g., via the communication interface 144 and the network 160) that is associated with the verification. Upon receipt, the electronic device 110 can then associate the user with his or her credentials as well as with any other suitable data stored in the database 150 such as, for example, healthcare data, task and/or schedule data, procedural data, protocol data, access permissions or restrictions data, environmental condition data, location data, asset status data, and/or the like. For example, based on the user's credentials, the electronic device 110 and/or the host device 130 can associate a subset of procedures from a total set of procedures stored in the database 150 that the user is authorized to perform. Similarly, the electronic device 110 and/or the host device 130 can associate a subset of locations, drugs, equipment, and/or the like that the user is authorized to access and/or utilize. For example, based at least partially on the user's credentials, the recommendation module 140 can determine a subset of tasks and/or permissions (e.g., protocols, procedures, locations, drugs, equipment, etc.) that the user is authorized to perform or access and can mark, flag, and/or otherwise store a reference to the associated data stored in the database 150. In some embodiments, the recommendation module 140 can be configured to cache or otherwise temporarily store the subset of tasks and/or permissions. In some instances, the database module 136 can receive an indication associated with the subset of tasks and/or permissions. In some instances, when the database module 136 queries the database 150 and/or the recommendation module 140 that data that is flagged and/or otherwise identified as the subset of tasks and/or permissions, the search or query can be reduced to the subset of data. In other words, based on, for example, a user's credentials, the data that is searchable (e.g., the data stored in the database 150 and searchable by the database module 136) can be substantially reduced to the subset of tasks and/or permissions. By identifying and/or storing the subset of tasks and/or permissions, real-time data received from the electronic device 110 can be analyzed, compared, associated, and/or verified faster than if the subset of tasks and/or permissions were not previously identified due, at least in part, to the subset of tasks and/or permissions being a smaller collection of tasks and/or permissions than the total set of tasks and/or permissions stored in the database 150.

In some instances, a user can select (e.g., by pressing a button, speaking a voice command, making a gesture, glancing at data on the display 118 of the electronic device 110, etc.) a location, a ward, or an area where he or she is planning to work and/or can select a type of work he or she is planning to perform for the day. In such instances, the analysis module 138 can perform an analysis (e.g., a speech recognition analysis, retina analysis, and/or the like) to define a set of data associated with user's selection. In some instances, the recommendation module 140 can mark, flag, and/or otherwise store a reference to any suitable corresponding and/or associated data stored in the database 150, as described above. In other instances, once a user is logged in (e.g., the user's credentials are verified), the electronic device 110 can record a video, take a photograph, scan a code (e.g., a RFID code, barcode, QR code, etc.) and/or utilize, for example, a global positioning system (GPS) and/or a real-time location system (RILS) to determine the location of the user and the electronic device 110 and can send a signal associated with the recorded video and/or the GPS or RILS data to the host device 130. In such instances, the recommendation module 140 can determine a subset of tasks and/or permissions based at least partially on the user's credentials and/or the data associated with the recorded video, photograph, scan, and/or the GPS or RILS data.

In some instances, the data stored in the database 150 that is searchable (e.g., by the database module 136) can be reduced, for example, the data can be reduced to a subset of data associated with, for example, location data (e.g., a patient's room, an inventory room, etc.) that is included in a subset of data associated with the user's credentials, which is a subset of data included in the total set of data stored in the database 150. In some instances, the subset of data that is searchable can be changed based on location and/or procedural data. For example, in some instances, the recommendation module 140 can be configured to flag and/or make searchable a subset of data that is associated with a user's credentials and can update the subset of data when, for example, the user begins a procedure. As such, the host device 130 (e.g., the database module 136 and/or the recommendation module 140) can be configured to limit the data that is searchable to the subset of data associated with the procedure. In some instances, the thus, the speed of real-time searching of data associated with the procedure can be increased.

In some instances, the host device 130 can provide a schedule, a patient list, and/or any other relevant data stored in the database 150 (e.g., as retrieved and/or received by the database module 136) that is associated with the user and/or the user's credentials to electronic device 110. In some instances, the host device 130 (e.g., the analysis module 138) can determine a workload of the user. For example, the analysis module 138 can determine the workload of the user of the electronic device 110 relative to other users of the system 100. In some instances, the host device 130 can be configured to rebalance a workload between any number of users of the system 100 based at least partially on the workloads of those users, locations of those users, unexpected events (e.g., emergency surgery and/or the like). Furthermore, the update module 142 can update data stored in the database 150 associated with those users to reflect the rebalanced workload.

In some instances, if a corresponding record of a user's credentials is not found in the database 150, the database module 136 can send a signal to the analysis module 138 that is associated with a negative response, a null set, and/or an indication that the user's credentials did not match those stored in the database 150. In this manner, the host device 130 can send a signal to the electronic device 110 that can cause the electronic device 110 to present an indication (e.g., a visual indication and/or an audio indication) to the user to, for example, re-state his or her credentials (e.g., username and password).

As described above, the electronic device 110 can be used to record a video of, for example, a clinical procedure to verify compliance with established protocols. In some instances, the user of the electronic device 110 can speak a command, press a button, and/or otherwise engage the electronic device 110 to indicate and/or select a clinical procedure to be performed. For example, in some instances, based on the location of the user and the electronic device 110 (e.g., a specific patient's room), the host device 130 can send a signal to the electronic device 110 to cause a subset of procedures from the set of procedures stored in the database 150 to be presented on the display 118 of the electronic device 110 (e.g., recommended and/or determined by the recommendation module 140). In some instances, the subset of procedures can be presented by the electronic device 110 based at least in part on entering the room of the patient, a user stating the patient's name, and/or scanning a barcode on an ID tag of the patient. The host device 130 can also send a signal to the electronic device 110 to cause the electronic device 110 to present any pertinent information associated with the patient (e.g., allergies, native language, indications, contraindications, precautions, safety concerns (e.g., related to air-born or blood-born pathogens), preferences, etc.).

With the subset of procedures presented on the display 118, the user can select the clinical procedure to be performed from the subset of procedures presented on the display 118. For example, the user can select the procedure by pressing a button, speaking the name of the procedure, and/or making a gesture detectable by one or more cameras on the electronic device 110. With the procedure selected, the electronic device 110 can send a signal the host device 130 associated with the selected procedure, which can, in turn, analyze the signal (e.g., at the analysis module 138) and retrieve any associated and/or corresponding data from the database 150 (e.g., via the database module 136). The host device 130 can then send a signal to the electronic device 110 to cause the electronic device 110 to present, for example, on the display 118, a protocol and/or a list of steps associated with the selected procedure.

With the protocol presented to the user (e.g., via the display 118 and/or via the output device 122), the user can begin the clinical procedure. Furthermore, the electronic device 110 can automatically begin to record a video of the procedure, record audio associated with the procedure, start a timer, make a time stamp, etc. In some instances, the electronic device 110 can automatically begin to record the video when the user enters the patient's room (e.g., as determined by scanning a bar code, QR code, etc., and/or via GPS or RILS data). In other instances, the user can engage the electronic device 110 and/or can make a gesture that is operable in causing the electronic device 110 to record the video of the procedure, record audio associated with the procedure, start the timer, make the time stamp, etc. For instance, the electronic device 110 can output an audio signal that is associated with a question to start recording the video of the procedure. As such, the user of the electronic device 110 can answer the question by speaking “yes,” and/or selecting a confirmation presented on the display 118. In some instances, the user can enter a patient's room and can select, for example, a procedure for inserting an IV into the patient, in a manner described above. With the procedure selected, the electronic device 110 can, for example, present the protocol for inserting an IV into a patient on the display 118 of the electronic device 110 and can automatically begin to record a video (e.g., with or without audio). In some instances, the protocol can include collecting the needed equipment to place the IV. In some instance, the electronic device 110 can record a video of the collection of the equipment. In other instances, the user can engage the electronic device 110 to scan, for example a bar code, an RFID code, a quick response (QR) code, and/or any other suitable tag.

The electronic device 110 can record the video and/or otherwise monitor the procedure of placing the IV in the patient and can send data associated with the video to the host device 130, which can, in turn, verify compliance with the protocol in substantially real-time (e.g., the analysis module 138 can compare the data received from the electronic device 110 to data associated with the protocol that is stored in the database 150 in substantially real-time). Upon verification of each procedural step, the host device 130 can send a signal to the electronic device 110 to cause the electronic device 110 to present an indication that the step of the procedure was performed according to the protocol. If, however, the analysis module 138 of the host device 130 determines that the data associated with the recording does not substantially correspond to the data associated with the protocol, the host device 130 can send a signal to the electronic device 110 to present an alert, indication, and/or notification to indicate to the user the of the step in the procedure that did not comply with the protocol.

In some instances, once the procedure has been performed according to the protocol, the update module 142 can update data associated with the patient (e.g., update and electronic medical record (EMR) stored in the database 150). For example, the update module 142 can update the data associated with the patient to include a time of the procedure (e.g., placing the IV into the patient), vital sign values at the time of the procedure, the user that performed the procedure, the size or gauge of the IV, a patient's preference regarding where the IV is placed (e.g., left arm or right arm), and/or any other relevant data. In some instances, the update module 142 can update billing information associated with the patient. For example, in some instances, the update module 142 can update billing information with a charge for the amount of time the user (e.g., a nurse, doctor, physician, technician, phlebotomist, etc.) spent to place the IV, a charge for the equipment used (e.g., as determined by the scanning of the equipment described above), and/or any other related expense. In this manner, the data associated with the procedure can be automatically recorded without the user having to manually record the procedure in a log or record.

In some instances, the electronic device 110 and/or the host device 130 can associate a status with the user of the electronic device 110. For example, during the procedure of placing the IV described above, the update module 142 can update data stored in the database 150 to reflect a busy status of the user of the electronic device 110. In some instances, the busy status can be viewable and/or can be monitored by any other user (e.g., an administrator, an attending physician, a department chief, etc.) of the system 100 and/or by the system 100 (e.g., to determine a workload or the like, as described above). Once the procedure has been completed according to the protocol, the update module 142 can update data stored in the database 150 to reflect an available status. In some instance, the status associated with a user and/or a schedule associated with the user can be changed and/or updated based on an activity, procedure, patient status, and/or the like. For example, in some instances, a caregiver can cover a task and/or procedure for another caregiver (e.g., user). In this manner, the status and/or schedule of the caregivers can be updated. In some instances, a procedure and/or the like can be updated and/or changed based on a patient status. For example, if a user of the electronic device 110 is providing care to a patient and while receiving care, the patient dies, the system 100 can be configured to update the status of the patient and/or update a subset of procedures associated with the patient. For example, if the next step in a procedure is to take the vital signs of a patient that just died, the system 100 can update the procedures due at least in part on the fact that you can't take vital signs of a deceased patient.

Although the system 100 is described above as facilitating a user's compliance with a protocol for a specific clinical procedure (e.g., placing the IV), in some instances, the system 100 can be used to facilitate any suitable clinical and/or administrative protocol. For example, the system 100 and more particularly, the electronic device 110 can be used to facilitate the user's compliance with, for example, a “rounds” protocol (e.g., a schedule for seeing patients). By way of example, in some instances, a hospital and/or medical center can have a rounds protocol that includes visiting a patient every hour an addressing specific needs of that patient (e.g., offering to take the patient to the restroom; checking the IV pump (if applicable); asking if the patient has any personal requests or needs; repositioning the patient in the bed for comfort and/or according to a turning protocol; and/or assessing a pain status). In some instances, the host device 130 and more particularly, the analysis module 138 and/or the recommendation module 140 can define a rounds schedule based at least partially on, for example, the user's credentials and/or assigned patients. In some instances, the electronic device 110 can automatically detect when the user enters a patients room (e.g., by taking a video or picture of a room number, scanning a bar code, using positioning data (GPS data and/or RILS data), etc.) and can send a signal to the host device 130 that is associated with the user entering the patients room. In other instances, the user of the electronic device 110 can verbally state the room number and/or patient name, and/or can select or press a button to select the patient from a list presented on the display 118 of the electronic device 110. In this manner, the host device 130 can send a signal to the electronic device 110 to cause the electronic device 110 to present, for example, a subset of procedures associated with the rounds protocol. Thus, the user can perform the procedures presented on the display 118 of the electronic device 110 and upon completion, the electronic device 110 can automatically send a signal to the host device 130 associated with the completion of the rounds procedures performed according to the rounds protocol. As described above, the update module 142 can be configured to update data stored in the database 150 to reflect the completion of the rounds protocol. In this manner, the data associated with the procedure can be automatically recorded without the user having to manually record the procedure in a log or record. Although described above as being recorded (e.g., via a video recording) by a camera or the like of the electronic device 110, in other embodiments, any suitable external recording device can be used to record the procedure (e.g., an externally mounted camera or the like in communication with the electronic device 110 and/or the host device 130). In some instances, video recorded from, for example, a camera included in or on the electronic device 110 and a video recorded from, for example, a stationary external camera (e.g., a wall or ceiling mounted camera) can be compared to ensure an accurate account and/or recordation of any or all of the steps included in the procedure.

In some instances, the system 100 can be configured to provide the user with, for example, an end of shift review and/or the like. For example, in some instances, the electronic device 110 can be configured to present an indication (e.g., on the display 118) associated with a confirmation that the user adhered to the policy and/or protocols during that shift. In some instances, the user can review data associated with the procedures that the user performed to verify compliance of the protocols. In some instances, the electronic device 110 can send a signal to the host device 130 associated with the end of the user's shift. In this manner, the system 100 can be configured to, for example, transfer responsibility of a patient(s) from the user to another user (e.g., caregiver). In some instances, the electronic device 110 can be configured to present data associated with the transfer of responsibility of the patient(s). In this manner, uncompleted procedures and/or the care of the patient(s) can be performed by the new user.

In some instance, the system 100 can be used to facilitate the admission and/or discharge of a patient. For example, in some embodiments, the user can state (e.g., speak) a verbal command such as, for example, “admit patient” or “discharge patient.” In this manner, the electronic device 110 and the host device 130 can facilitate the user's compliance to the admission or discharge protocols, respectively, in a similar manner as described above. In some instances, the update module 142 of the host device 130 can update the database 150 to reflect the admission of a new patient, for example, by defining an EMR for the new patient that can include any suitable health, insurance, and/or payment information. Similarly, the update module 142 of the host device 130 can update the database 150 to reflect the discharge of a patient. In some embodiments, the update module 142 and/or any other suitable portion of the host device 130 can automatically generate, for example, a bill for the patient based at least partially on the EMR for that patient that was automatically recorded and updated via the system 100. In some embodiments, the host device 130 can include a module or set of modules that can define an invoice and/or that can automatically send a bill to, for example, the patient's email account, health insurance, and/or a combination thereof.

In some instances, the host device 130 can store, in the database 150, a standard time period to perform a procedure. By way of example, the host device 130 and/or the electronic device 110 can be configured to monitor a length of time it takes for a user to perform a procedure according to the protocol (e.g., 10 minutes to place an IV in a patient). If the length of time for the user to perform the procedure exceeds the standard time period, in some instances, the host device 130 can send a signal to the electronic device 110 to cause the electronic device 110 to present and alarm or a notification. In some embodiments, the alarm and/or notification can be sent to an administrator and/or attending physician. Therefore, if a user is having difficulty performing a procedure on a patient, (e.g., due to an uncooperative patient and/or for any other reason) any other user of the system 100 can be alerted and, if available, can provide support to the user of the electronic device 110. In some embodiments, the host device 130 can store, in the database 150, information associated with average time of procedures for a user and/or for a group of users. In such embodiments, the host device 130 can define, for example, standard times for procedures based on averages times and/or any other historical data from the user or from a group of users that is stored in the database 150. While the electronic device 110 and/or the host device 130 is described above as outputting an alert based on a verification and/or lack of verification of a protocol, in other embodiments, the user can engage the electronic device 110 (e.g., by making a gesture, pushing a button, stating a command, etc.) to indicate a need for assistance. For example, if a user needs a device or tool that is located, for example, in a storage room or the like, the user can engage the electronic device 110 to indicate such a need. In some instances, a different healthcare professional, staff member, and/or user can, retrieve the needed device and/or tool and deliver it to the user making the request.

In some instances, the host device 130 and/or the electronic device 110 can store a standard time period and/or interval associated with, for example, a cardiopulmonary resuscitation (CPR) procedure. For example, in some instances, the host device 130 can determine a CPR procedure is being performed (e.g., using any of the methods described above) and send a signal to the electronic device 110 associated with timing data (e.g., beats per minute) and/or the like. In this manner, the electronic device 110 can provide an indicator (e.g., on the display 118 or via the output device 110) that can be associated with an interval for chest compressions. Although described above as receiving data from the host device 130, in other embodiments, the electronic device 110 can be configured to store data associated with a subset of critical and/or crisis procedures. Thus, the electronic device 110 can perform any suitable process and/or function to facilitate the user in performing the crisis procedure (e.g., the CPR procedure) without sending signals to and/or receiving signals from the host device 130. After the procedure, however, the electronic device 110 can be configured to send a signal to the host device 130 including any relevant data associated with the crisis procedure and/or its outcome.

As described above, the system 100 can be used to update, monitor, and/or otherwise indicate a status to any user of the system. The host device 130 can update a status of a user and/or of a drug or equipment based on any suitable parameter. In some embodiments, the status of a user can be based at least in part on a location of the user of the electronic device 110. For example, in some instances, the user can enter a non-sterile environment such as, for example, a restroom. The electronic device 110 can send a signal to the host device 130 that can be associated with a photograph and/or a scan of any identifier of the non-sterile environment. In other instances, the electronic device 110 can send a signal to the host device 130 that can be associated with GPS data, RILS data, and/or the like. Thus, the host device 130 can determine a subset of protocols associated with the non-sterile environment and can send a signal to the electronic device 110 to cause the electronic device 110 to present the protocols (e.g., on the display 118 and/or via the output device 122). For example, a subset of protocols could include washing your hands prior to exiting the non-sterile environment. In some instances, the host device 130 can send a signal to the electronic device 110 that is indicative of an instruction to present a confirmation of compliance to the protocol upon exiting the non-sterile environment. For example, when the user exits the non-sterile environment, the electronic device 110 can present (e.g., on the display 118 and/or via the output device 122) a confirmation request associated with, for example, the user washing his or her hands. Therefore, the user of the electronic device 110 is reminded of the protocol to wash his or her hands prior to exiting the non-sterile environment and after washing his or her hands, the user can confirm compliance to the protocol.

In some instances, the system 100 can be configured to update a procedure and/or protocol based on data from one or more user (e.g., caregiver). For example, in some instances, a doctor and/or the like (e.g., a user) can perform a procedure on a patient and can during the procedure, may ask for a second opinion from one or more other users in the patient's room. In this manner, the system 100 can be configured to record the opinions of the doctor and the other caregivers. In some instances, the course of action can be updated based on the opinions of the users. In some instances, the host device 130 can be configured to store and/or update data associated with the procedure, the user, and/or the patient based on the updated course of action.

In some instances, the system 100 can be configured to provide remote authorization to a user of the electronic device 110. For example, in some instances, a nurse and/or other caregiver can attend a patient and assess that a change in dosage of a medication is needed. In some instances, however, the nurse may not be authorized to adjust the dosage of the medication. In such instances, the nurse can engage the electronic device 110 to send a signal to the host device 130 associated with a request for authorization to increase the dosage of the medication. In turn, the host device 130 can query the database 150 to determine, for example, a primary care physician, a secondary care physician, a registered nurse, and/or any other caregiver of the patient that is authorized to change the dosage of the medication. In some instances, the host device 130 can send a signal to, for example, an electronic device associated with the user that is indicative of the request for authorization. Thus, if the authorized user indicates that the nurse is authorized to increase the dosage, the host device 130 can send a signal to the electronic device 110 to present the user with an indication of the authorization. Although the host device 130 is described as sending a signal to the authorized users via an electronic device (e.g., similar to the electronic device 110), in some instances, the host device 130 can send a signal to the authorized users that is in, for example, a short message service (SMS) format, a multimedia message service (MMS) format, an email format, an instant message format, a telephonic format, and/or the like.

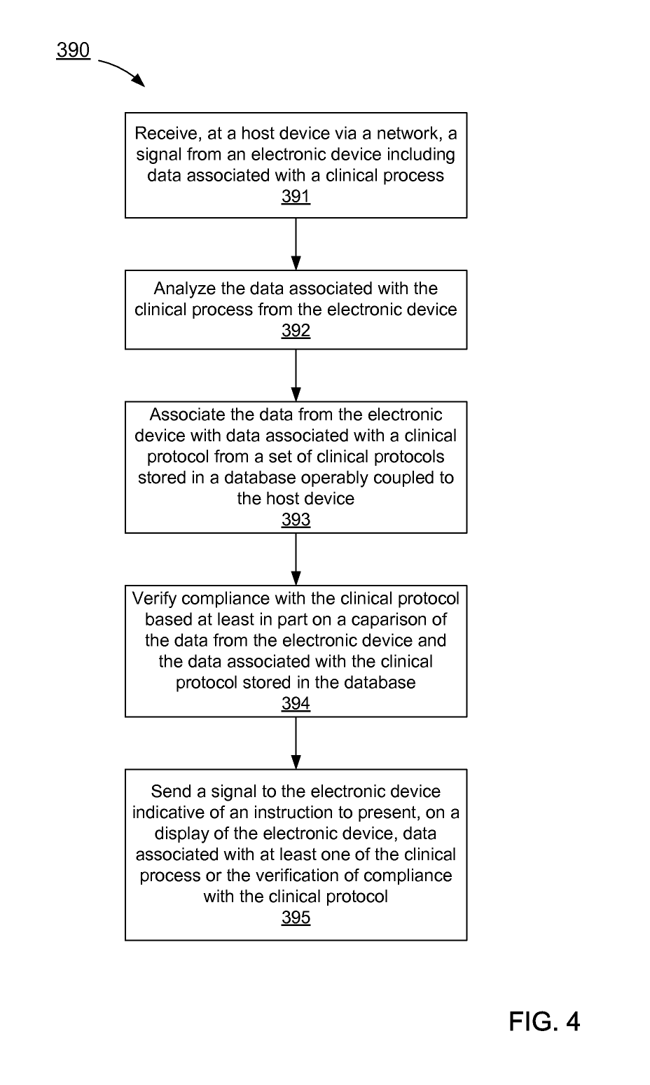

FIG. 4 is a flowchart illustrating a method 390 of using a compliance verification system according to an embodiment. The method 390 includes receiving, at a host device via a network, a signal from an electronic device including data associated with a clinical process, at 391. In some embodiments, the electronic device can be, for example, a wearable mobile electronic device such as the electronic device 110 described above with reference to FIGS. 1 and 2. The host device can be any suitable compute device. For example, in some embodiments, the host device can be substantially similar to the host device 130 described above with reference to FIGS. 1-3. The host device can include and/or can be operably coupled to a database that can store, for example, electronic medical records, protocol information, user information and/or profiles, schedules, and/or the like.

In some embodiments, the signal sent from the electronic device can be associated with a location of the user and/or the electronic device; a selection of a procedure from a subset of procedures presented on a display of the electronic device; a gesture; a verbal statement, command, request, and/or utterance; a substantially real-time video from, for example, a camera of the electronic device; and/or any combination thereof. The method includes analyzing the data associated with the clinic process from the electronic device, at 392. For example, in some embodiments, the host device can include a module such as the analysis module 138 in FIG. 3 that is configured to perform, for example, a speech recognition analysis, a video recognition analysis, and/or any other suitable analysis to define an analyzed data set.

The data from the electronic device that was analyzed is associated with data associated with a clinical protocol from a set of clinical protocols stored in the database, at 393. For example, in some embodiments, the user can select a procedure from a subset of procedures presented of the display of the electronic device. In such embodiments, the signal sent from the electronic device can include an indication of the selected procedure. In this manner, the host device can associate the data with the corresponding clinical protocol from the set of clinical protocols stored in the database. The method includes verifying compliance with the clinical protocol based at least in part on a comparison of the data from the electronic device and the data associated with the clinical protocol stored in the database, at 394. For example, in some embodiments, an analysis module of the host device can be configured to compare, in substantially real-time data from the electronic device with data associated with the clinical protocol stored in the database (e.g., a real-time video stream and/or the like). In some instances, the host device can determine a step of the protocol (e.g., based at least partially on the real-time video and/or any other data received from the electronic device) and can send a signal to the electronic device to cause the electronic device to present a request to confirm the data associated with the completion of the process step during the procedure that corresponds the to the step of the protocol. The user can confirm the process step by any of the methods described above with reference to the electronic device 110. Once confirmed, the electronic device can send a signal to the host device and, upon receipt, the host device the completion of a process step has been confirmed and is in accordance with the protocol. In some instances, the host device can, for example, update data stored in the database to reflect the completion of the process step.

A signal is sent to the electronic device that is indicative of an instruction to present, on the display of the electronic device, data associated with at least one of the clinical process or the verification of compliance with the clinical protocol, at 395. For example, in some embodiments, the host device can determine that the user confirmed a process step was performed in compliance with the corresponding clinical protocol and can send the signal to the electronic device to cause the electronic device to present an indication that the procedure performed by the user of the electronic device was in compliance with the clinical protocol (e.g., present a check mark or the like on the display of the electronic device and/or output an audio confirmation). In some instances, if the comparison of the data from the electronic device and the clinical protocol results in non-compliance, the host device can send a signal to the electronic device that can cause the electronic device to present a notification, an alarm, and/or a recommendation associated with the step of the procedure that diverted from the clinical protocol. As such, the user can return to that step to ensure compliance. Thus, by recording and analyzing data associated with the clinical process, compliance to a set of protocols can be ensured and, for example, a log of the user's activities can be record in a substantially automatic manner without the user having to manually input information into a log.

As described above, a system such as, for example, the system 100 can be configured to include a wearable electronic device and a host device and can be used to verify compliance with established protocols. For example, the host device can store, for example, a set of clinical and/or corporate protocols that are to be followed by caregivers of a hospital and/or medical center. As described above, a user can input his or her credentials (e.g., by speaking a username and password and/or via a retina, fingerprint, barcode, RFID, and/or QR scan) to be associated with the electronic device. The host device can verify the user's credentials (e.g., by querying a database and/or the like) and once verified, the user can be associated with the electronic device, as described in detail above. With the user associated with the electronic device, the host device can be configured to select, predefine, cache, indicate, identify, temporarily store, etc. a subset of procedures that the user is authorized to perform. The subset of procedures can be based, at least partially, on the user's credentials, a location of the user, a schedule, a workload, and/or the like.

In some instances, the electronic device and/or the host device can store a schedule for delivering a drug formulation (e.g., insulin) to a patient. In such instances, the host device can send a signal to the electronic device to cause the electronic device to notify the user (e.g., on a display of the electronic device and/or any other output method) that it is time to administer the insulin to the patient. In some instances, the user can enter the patient's room and based on the location of the user and the electronic device, the host device can send a signal to the electronic device to cause the electronic device to present a confirmation request such as, for example, “are you here to deliver insulin to Mr. Smith?” More particularly, based on the location of the electronic device and the association of the electronic device with the user, the host device can determine a subset of procedures that the user is authorized to perform. Moreover, with the host device storing, in the database, a schedule for delivering insulin to Mr. Smith and with the location of the electronic device being determined to be Mr. Smith's room, the host device can reduce the subset of procedures and determine the likely purpose of the visit to Mr. Smith being to administer the insulin.

The user can confirm the procedure of delivering insulin to Mr. Smith using any of the methods described in detail above. The electronic device can send a signal to the host device associated with the confirmation and, upon receipt, the host device can query the database for the protocol associated with administering insulin. The host device can then send a signal to the electronic device to present (e.g., on the display of the electronic device) the steps of the procedure and/or protocol of administering insulin. Furthermore, the host device can send a signal to the electronic device indicative of an instruction to start recording a video and/or an audio feed. In other instances, the user can engage the electronic device manually to start the video and/or audio recording.

With the video and/or audio recording, the user can begin the clinical procedure. In some instances, the electronic device and/or host device can automatically start a timer, make a time stamp, and/or the like. In some instances, the procedure can start with the user washing his or her hands. In some instance, the electronic device can present a confirmation request associated with the step of hand washing. Therefore, once the user washes his or her hands according to the protocol (e.g., a duration, an amount of soap, and/or the like), the user can verify the completion of the procedural step according to the protocol by, for example, stating that the step is completed, making a gesture (e.g., with his or her hands and/or with his or her eyes), pressing a button, and/or the like, as described in detail above. The electronic device can send a signal to the host device associated with the confirmation of compliance to the first step of the protocol and upon receipt, the host device can, for example, update the database with data reflecting the completion of the step.

In some instances, the protocol can include scanning an identification code of the patient (e.g., a bracelet or the like). In this manner, the electronic device can send a signal to the host device associated with the scanned code and the host device can confirm the patient's identity. In some instances, once confirmed, the host device can send a signal to the electronic device to cause the electronic device to present any relevant data associated with the patient (e.g., on the display of the electronic device). For example, the host device can send a signal to the electronic device that can include data associated with, for example, a dosage of insulin to be administered to Mr. Smith. Furthermore, scanning the identification code of the patient can facilitate billing the patient for the treatment.

With the dosage information presented to the user, the user can, for example, fill a syringe to the indicated dosage level and can confirm (e.g., as described above) that the syringe has been filled according to the protocol. The electronic device can send a signal to the host device associated with the completion of the process step in accordance with the protocol.

In some instances, once the syringe has been filled with the correct dosage, the protocol can include administering the insulin to Mr. Smith, which can include, for example, placing the syringe in fluid communication with an IV or the like. The user can confirm that the dosage of insulin has been administered to Mr. Smith according to the protocol using any of the methods described above. Once confirmed, the electronic device can send a signal to the host device associated with the completion of the process step in accordance with the protocol.

In some instance, the protocol can include a final step of disposing the syringe in, for example, a sharps container. Thus, once the user disposes the syringe in the sharps container, the user can confirm that the syringe has been disposed of according to the protocol. Once confirmed, the electronic device can send a signal to the host device associated with the completion of the final process step in accordance with the protocol. Furthermore, with each process step being completed according to the protocol, the host device can, for example, update data stored in the database to reflect that the insulin was administered to Mr. Smith. In some instances, the updated data can include the caregiver (e.g., user) that delivered the insulin, the dosage, a time of delivery, a duration of the procedure, and/or any other suitable data. Moreover, in some instances, the status of the user can be changed from, for example, a busy status to an available status, as described in detail above. Although described above as sending a confirmation of compliance to the protocol at the end of each process step, in other embodiments, the electronic device can be configured to store any or all data associated with the procedure of administering the insulin to Mr. Smith. In such embodiments, the electronic device can send the data to the host device once the procedure has been completed. In other embodiments, the electronic device can store the data associated with the procedure until the electronic device is placed, for example, in a docking station and/or the like.

In some instances, the host device and the electronic device can be configured to present, for example, a suggested script to be recited by the user to the patient. For example, in some instances, the electronic device can present on the display a script associated with each process of the procedure. In this manner, the user can visualize the script and use it as, for example, a template to explain the procedure to the patient.

Although the example described above includes following a set of procedures in a substantially synchronous (e.g., linear, predetermined, and/or chronological) manner to verify compliance of a clinical protocol, in other instances, any suitable number of steps included in some clinical procedures can be performed asynchronously while remaining within compliance of the clinical protocol. Said another way, in some instances, at least some steps and/or processes of a procedure can be performed in any suitable order while remaining compliant to a given clinical protocol. In some instances, certain steps and/or processes (e.g., a subset of steps and/or processes) of a procedure can be performed in any suitable order while other steps included in that procedure may need to be performed in a predetermined order. By way of example, in some instances, a user can verify his or her credentials with any of the electronic devices described herein and can engage the electronic device to perform a clinical procedure such as, for example, placing an IV. In some instances, upon entering a patient's room, the user can verify the clinical procedure of placing the IV, as described in detail above. With the procedure selected, the electronic device can begin recording the procedure (as described above) and can prompt the user to perform the first step of the procedure (e.g., the electronic device can present the first step of the procedure on the display, as described in detail above).

In some instances, the procedure can start with a mandatory first step of the user washing his or her hands. In such instances, the electronic device can verify the step of the user washing his or her hands and can prompt the user to confirm the completion of the first step. As described above, in some instances, the first step of the user washing his or her hands can be a mandatory step that is performed first to comply with the clinical protocol associated with placing the IV. That is to say, no other step of the procedure can be performed prior to the user washing his or her hands, according to the protocol. Thus, if a step is performed prior to the user washing his or her hands the electronic device can notify the user of a noncompliance. Once the user has washed his or her hands the electronic device can, for example, present the second step of the procedure. In some instances, for example, the second step can be donning gloves. Once the second step is completed and compliance with the protocol is verified, the electronic device can, for example, present the third step of the procedure. For example, the third step can be donning a surgical mask or the like and once completed, compliance with the protocol can be verified.

As described above, in some instances, certain steps of a procedure can be performed in an asynchronous manner while still complying with the clinical protocol. For example, while the second step of donning gloves is described as being performed prior to the third step of donning the surgical mask, in other instances, the user can don the surgical mask prior to donning the gloves and can remain within compliance of the protocol. That is to say, the second step and the third step (e.g., a subset of steps and/or processes) can be performed in any suitable order (i.e., asynchronous). In some instances, a host device such as those described herein can, for example, store data (e.g., in a database) associated with each order of performing the steps. Thus, performing the step of donning the surgical mask prior to the step of donning the gloves remains in compliance with the protocol. As described above, however, the step of donning the gloves and the step of donning the surgical mask are performed after the user washes his or her hands to remain in compliance with the clinical protocol.

With the third step completed and verified (as described above), the electronic device can display the fourth step of the procedure to the user. In some instances, the fourth step of the procedure can be scanning an identification code of the patient (e.g., a bracelet or the like). In this manner, the patient's identity can be verified and once confirmed, the electronic device can verify the fourth step as being completed and in compliance with the protocol (as described above). In some instances, the protocol can be such that the step of the user donning the gloves and the step of the user donning the surgical mask are performed prior to scanning the identification code of the patient. Thus, if the user performs the step of scanning the identification code prior to donning the glove and/or the surgical mask, the electronic device can alert the user of a non-compliance with the protocol. That is to say, while the order of donning the gloves and donning the surgical mask can be performed in any order, each are performed prior to scanning the identification code of the patient to remain in compliance. Therefore, in some instances, each step and/or process included in a subset of steps and/or processes can be performed asynchronously, while the subset as a collective whole is performed in a synchronous manner with the remaining process steps and/or processes other than those included in the subset. With the fourth step verified as being in compliance with the protocol, the remaining steps of placing the IV can be performed in a similar manner as described in detail above.

In some embodiments, a host device and/or an electronic device such as those described herein can be configured to be adaptive. For example, in some instances, the host device can store the protocol associated with placing the IV such that the process step of donning the gloves is performed prior to donning the surgical mask. A given user, however, may prefer to don the surgical mask prior to donning the gloves and thus, performs the procedure in this manner. The electronic device can send a signal to the host device associated with, for example, a recording of the process steps of donning the surgical mask and donning the gloves. As such, the host device can verify compliance of the protocol and can, in some instances, send a signal to the electronic device that is indicative of an instruction to ask the user if he or she prefers donning the surgical mask prior to donning the gloves. If the user confirms that he or she prefers this order, the host device can, for example, update data associated with the user to reflect his or her preferred order of the process steps for the protocol of placing the IV. Thus, some protocols can be updated to reflect a given user's preference while remaining compliant to the protocol (as described above). In some such embodiments, the host device can update data associated with a particular user's preferences without any confirmation from the user.

While the example described above includes one or more synchronous steps, followed by one or more asynchronous steps, followed by one or more synchronous steps, in some embodiments, procedures can be different combinations of one or more synchronous and asynchronous steps. In some embodiments, the electronic device can display more steps of a given procedure than the current step to be performed, for example, upcoming steps, steps previously performed, and/or multiple steps that can be performed in an asynchronous order. As described herein, the electronic device and/or the host device can store when and in what order the steps of a procedure were completed. In such embodiments, if a step is not performed in the correct order, or at all, the electronic device and/or the host device can store an indication that a step was not completed, or was completed in incorrect order. In some such embodiments, the electronic device and/or the host device can continue to monitor compliance with the procedure, for example, record when steps are performed and/or otherwise allow a user to continue with the procedure.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above. Furthermore, while shown as described above with respect to certain specific scenarios, for example, inserting an IV, administering a dose of insulin, etc., any other clinical procedure and activity can be used. Finally, while described with respect to a clinical/medical environment, the systems and methods for verifying protocol compliance using a mobile electronic device described herein can be used in other environments where compliance with protocol is used, for example, legal, accounting, inventory, retail, military, etc.

Although the systems and methods are described above as recording data associated with tasks and/or procedures, in other embodiments, the systems and/or methods described herein can be used to record readouts and/or the like from, for example, legacy devices and/or the like. For example, in some instances, the user can engage an electronic device (such as those described above) to capture an image (e.g., via a camera) of a readout including procedural and/or protocol compliance data and/or the like. In some instances, a user can engage an electronic device to capture an image of a display and/or the like of a medical device that is not connected to the system. For example, in some instances, the user can engage the electronic device to capture a picture of a vital sign display. In such instances, the electronic device can send a signal to a host device (such as those described herein) associated with the picture and, in turn, the host device can determine, for example, the type (e.g., brand information, model information, layout information, etc.) of medical device based on, for example, optical character recognition (OCR) and/or the like. In this manner, the host device can determine the type of medical device and based on determining the type of medical device, the host device can organize, analyze, and/or characterize data (e.g., e.g., video data and/or the like received from the electronic device) associated with that medical device.

Although the systems and methods are described above as facilitating the compliance with protocols at, for example, a corporate or procedural level, in other instances, the systems and methods described herein can be used to verify compliance with protocols established by, for example, the Joint Commission on Accreditation of Hospitals and/or by insurance companies. For example, in some instances, the systems and methods described herein can be used to produce daily, weekly, monthly, quarterly, annually, etc. reports to, for example, an insurance company insuring a medical center. Since, verification to protocols is performed substantially automatically and substantially in real-time, the burden of supplying such reports can be greatly reduced. Moreover, in some instances, the substantially automatic recordation (e.g., video and/or audio) of process steps during a procedure can be used, for example, to defend against fraudulent medical malpractice and/or medical negligence suits.

Where schematics and/or embodiments described above indicate certain components arranged in certain orientations or positions, the arrangement of components may be modified. Similarly, where methods and/or events described above indicate certain events and/or procedures occurring in certain order, the ordering of certain events and/or procedures may be modified. While the embodiments have been particularly shown and described, it will be understood that various changes in form and details may be made.

Although various embodiments have been described as having particular features and/or combinations of components, other embodiments are possible having a combination of any features and/or components from any of embodiments as discussed above.

1. A method, comprising:
receiving, at a host device from a mobile device, a signal indicative of a credential of a user of the mobile device, the host device associated with a database storing a plurality of medical procedures;
associating, based on the credential, a first subset of medical procedures from the plurality of medical procedures with the mobile device, the first subset of medical procedures including fewer medical procedures than the plurality of medical procedures;
receiving, at the host device from the mobile device, a signal indicative of healthcare data;
sending a signal configured to cause a display associated with the mobile device to display, based on the healthcare data, a second subset of medical procedures from the first subset of medical procedures, the second subset of medical procedures including fewer medical procedures than the first subset of medical procedures;
receiving, at the host device from the mobile device, a signal indicative of a selection of a medical procedure from the second subset of medical procedures; and
sending a signal configured to cause the display to display a first step of the medical procedure.

2. The method of claim 1, further comprising sending a signal configured to cause the display to display, in response to a determination that the first step of the medical procedure was completed, a second step of the medical procedure.

3. The method of claim 1, wherein the healthcare data is a first healthcare data, further comprising:
receiving, at the host device from the mobile device, a second healthcare data;
sending a signal configured to cause the display to display, in response to a determination that is based on the second healthcare data that a second step of the medical procedure is not necessary, a third step of the medical procedure.

4. The method of claim 1, further comprising storing, based on the determination that the first step is completed, an indication of a completion of the first step.

5. The method of claim 1, wherein the credential includes at least a username.

6. The method of claim 1, wherein the credential is associated with certification of the user.

7. The method of claim 1, wherein the healthcare data is at least one of a medical condition of a patient or an attribute of a clinical environment.

8. The method of claim 1, wherein the healthcare data is at least one of a location of a patient, a location of a caregiver, or a location of an asset.

9.-25. (canceled)

26. The method of claim 1, further comprising receiving a signal indicative of a completion of the first step of the medical procedure.

27. The method of claim 26, wherein the signal indicative of the completion of the first step of the medical procedure is based on gesture by a user of a mobile device.

28. The method of claim 26, further comprising storing an indication of the completion of the first step.

29. The method of claim 26, wherein the signal indicative of the completion of the first step of the medical procedure is based on an audio indication from a user of the mobile device.

30. The method of claim 26, further comprising generating a report, the report including the indication of the completion of the first step.

31. The method of claim 1, wherein the first subset of medical procedures only includes medical procedures from the plurality of medical procedures that a user of a mobile device is authorized to perform.

32. The method of claim 1, wherein the second subset of medical procedures only includes medical procedures from the first subset of medical procedures that are authorized to be performed on a patient of a user of a mobile device.

33. The method of claim 1, further comprising:
retrieving, based on a patient identification sent from the mobile device, healthcare data; and
defining, based on the healthcare data and a characteristic of the user of the mobile device, the second subset of medical procedures.

34. A method, comprising:
receiving, at a host device from a mobile device, a signal indicative of a credential of a user of the mobile device, the host device associated with a database storing a plurality of medical procedures;
associating, based on the credential, a first subset of medical procedures from the plurality of medical procedures with the mobile device, the first subset of medical procedures including fewer medical procedures than the plurality of medical procedures;
sending a signal to the mobile device to cause a display module to display a second subset of medical procedures, the second subset of medical procedures being from the first subset of medical procedures, the second subset of medical procedures based on at least one of a location of a patient, a location of a caregiver, or a location of an asset,
sending a signal to the mobile device to cause the display module to display a first step of a medical procedure from the second subset of medical procedures,
receiving a signal indicative of a completion of the first step of the medical procedure,
sending a signal to the mobile device to cause the display module to display a second step of the medical procedure.

35. The method of claim 34, wherein the signal indicative of the completion of the first step is based on gesture by a user of the mobile device.

36. The method of claim 34, wherein the first subset of medical procedures only includes medical procedures from the plurality of medical procedures that the user of the mobile device is authorized to perform.

37. The method of claim 34, wherein the second subset of medical procedures only includes medical procedures from the first subset of medical procedures that are authorized to be performed on a patient of the user of the mobile device.

38. A method, comprising:
sending, from a mobile device to a host device, a signal indicative of a credential of a user of the mobile device, the host device (1) associated with a database storing a plurality of medical procedures and (2) configured to associate, based on the credential, a first subset of medical procedures from the plurality of medical procedures with the mobile device, the first subset of medical procedures including fewer medical procedures than the plurality of medical procedures;
displaying (1) a first step of a medical procedure from the first subset of medical procedures and (2) a second step of the medical procedure,
sending, to the host device, a signal indicative of a completion status of the first step of the medical procedure,
sending, to the host device, a signal indicative of a completion status of the second step of the medical procedure, such that the host device stores, based on the completion status of the first step of the medical procedure and the completion status of the second step of the medical procedure, a compliance report.

39. The method of claim 38, further comprising:
sending the signal indicative of the completion status of the second step of the medical procedure at a first time.
sending the signal indicative of the completion status of the first step of the medical procedure at a second time after the first time.

40. The method of claim 38, wherein when the completion status of the second step of the medical procedure is not completed, the processor module is configured to cause the display module to display an alert.

41. The method of claim 38, further comprising:
receiving an indication of a selection of the medical procedure,
causing, in response to the selection, a video capture module to begin recording video to define a video recording of a performance of at least the first step of the medical procedure.

42. The method of claim 38, further comprising causing the host device to associate the video recording with the compliance report.

43. A method, comprising:
sending, from a mobile device to a host device, a signal indicative of a credential of a user of the mobile device, the host device (1) associated with a database storing a plurality of medical procedures and (2) configured to associate, based on the credential, a first subset of medical procedures from the plurality of medical procedures with the mobile device, the first subset of medical procedures including fewer medical procedures than the plurality of medical procedures;
sending, from the mobile device to the host device, a signal indicative of healthcare data;
displaying associated with the mobile device to display, based on the healthcare data, a second subset of medical procedures from the first subset of medical procedures, the second subset of medical procedures including fewer medical procedures than the first subset of medical procedures;
sending, from the mobile device to the host device, a signal indicative of a selection of a medical procedure from the second subset of medical procedures; and
displaying to display a first step of the medical procedure.

44. The method of claim 43, further comprising recording video to define a recording of a performance of the first step of the medical procedure.
